(19) United States
(12) Patent Application Publication
(10) Pub. No.: US 2005/0087216 A1
(43) Pub. Date: Apr. 28, 2005

(54) Exterior surface cleaner and method of use

(76) Inventor: Scott B. Dudjak, Sugar Land, TX (US)

Correspondence Address: Richard C. Litman;LITMAN LAW OFFICES, LTD., P.O. Box 15035, Arlington, VA, 22215, US

(21) Appl. No.: 10/911,502

(22) Filed: Aug. 5, 2004

Related U.S. Application Data
(60) Provisional application No. 60/513,192, filed on Oct. 23, 2003.

(51) Int. Cl. B08B 9/027

(52) U.S. Cl. 134/42

(57) ABSTRACT

A method is provided for cleaning an exterior surface that is stained as a result of biological growth of an organism, such as algae, lichen, or moss. The method includes applying a cleaning composition having an effective amount of alkyl-dimethyl-benzyl-ammonium-chloride to the exterior surface. A method is also provided for preventing biodeterioration of an exterior surface. The method includes applying a cleaning composition having alkyl-dimethyl-benzyl-ammonium-chloride to the exterior surface. An exterior surface cleaning formulation has an effective amount of alkyl-dimethyl-benzyl-ammonium-chloride.

### CROSS-REFERENCE TO RELATED APPLICATION

This application claims the benefit of U.S. Provisional Patent Application Ser. No. 60/513,192, filed Oct. 23, 2003.

### BACKGROUND OF THE INVENTION

1. Field of the Invention

The present invention relates to an improved method and composition for cleaning exterior surfaces. More specifically, the invention is directed to an improved method and composition for removing stains on a roof, stucco or outside walls caused by, for example, algae (such as Gloeocapsa magma) moss, mildew and lichen. The invention is also directed to a composition for use as a preventative agent to help prevent the developments of bio-stains on an exterior surface.

2. Description of the Related Art

Gloeocapsa magma is an alga that can grow in a wide range of climates, but particularly likes to grow in humid environments. Moss, mildew and lichen are prevalent in dryer climates. Wind and animals, such as birds, help to spread Goieocapsa magma across wide areas, including neighborhoods. Unfortunately for house and building owners, Gloeocapsa magma causes streaks and discoloration in roofs made of shingle containing ground up limestone. Specifically, Gloeocapsa magma produces dark-colored cells that discolor and cause unattractive streaks on roofs, outside walls, siding, and stucco. In addition, algae-derived mineral nutrients found in fillers, such as calcium carbonate used in asphalt and calcium oxide in concrete shingles, can encourage unwanted growth of algae, lichens, moss, mold, and mildew. Houses and neighborhoods blighted with Gloeocapsa magma are less likely to appeal to house buyers. In addition, moss, mildew and lichen can cause stain (or more accurately “bio-stain”) build-up on, for example, roofs, stucco and brick walls. Thus, there is a need for a cleaning composition and method that can safely remove such stain build-up on exterior surfaces, such as a roof.

Biodeterioration, i.e., the breakdown or harm to materials of commercial value, places a severe burden on the economy. For example, owners of modern houses are faced with biodeterioration problems, such as the prospect of a roof that is vulnerable to staining caused by Gloeocapsa magma. In addition, the appearance of discolored algae, such as black algae, on roofs and outside walls can lead to an increase in absorption of infrared energy in sunlight, resulting in increased cooling or air-conditioning costs for affected buildings. Thus, building owners need an environmentally acceptable material that can prevent such problems. Specifically, building owners need a safe, non-medical prophylactic or “preventative” to guard against or substantially reduce prospective biodeterioration.

Cleaning compositions based on free chlorine can cause severe damage to a property. Free chlorine, especially in the form of hypochlorous acid (HOCl), tends to chlorinate with inanimate matter, i.e., addition or substitution of a chlorine atom into the inanimate matter with which the hypochlorous acid is in contact. While hypochlorous acid can destroy most organisms, such as plants and/or microbes, in a short time period, its ability to react with and chlorinate compounds makes it unsuitable for use as a stain or bio-stain removing agent. In addition, because hypochlorous acid is so reactive, it is not useful as a preventative.

Applying strong or reactive chemicals to exterior surfaces can be problematic. For example, some chemicals, such as sodium hydroxide (Lye), can destroy vegetation, burn skin and eyes and damage roof material by reacting with, for example, the shingle component of a modern roof. Applying strong solutions of potassium hydroxide can likewise be problematic. Such chemicals can cause severe burns, and accidental splashes can lead to serious damage to unprotected eyes and skin.

Zinc and copper are known to be toxic to Gloeocapsa magma. Thus, strips of zinc and copper can be added to roof limestone based roof shingle. Over time the zinc or copper will leach out and help inhibit further growth of this algae. However, the use of such strips does not deal with the problem of stains and blotches already present on the roof. Thus, there is a need for a cleaning agent that can remove the stains already present as a result of past growth and colonization by, for example, algae (such as Gloeocapsa magma), moss, mildew and lichen. In addition, the leaching out process may not provide sufficient coverage of a roof, thus negating the usefulness of such strips as a preventative.

U.S. Pat. No. 4,272,395, issued Jun. 9, 1981 to Wright, describes a high-foaming, germicidal detergent composition suitable for use in dishwashing and in the cleaning and disinfecting of hard surfaces. The Wright '395 composition comprises a quaternary ammonium compound and a short chain anionic surfactant. The Wright '395 does not teach or suggest using their composition to clean or prevent stains on a roof, stucco or outside walls caused by, for example, algae (such as Gloeocapsa magma), moss, mildew and lichen.

U.S. Statutory Invention Registration Number H269, published May 5, 1987, describes a liquid disinfectant and/or sanitizer cleaning composition in the form of a homogeneous aqueous solution that comprises water., a germicidal quaternary ammonium halide compound and a glycoside surfactant. The Malik H269 publication does not teach or suggest using the composition to clean or prevent stains on a roof, stucco or outside walls caused by, for example, algae (such as Gloeocapsa magma), moss, mildew and lichen.

U.S. Pat. No. 4,320,147, issued Mar. 16, 1982 to Schaeufele, describes a hospital-strength disinfectant cleaner having both organic soil tolerance and disinfectant hard water tolerance comprising, as active ingredients, alkyl dimethyl benzyl ammonium chloride and octyl decyl dimethyl ammonium chloride. The cleaner is an aqueous solution containing at least 800 ppm of the active ingredients and demonstrates disinfectant activity in water having a hardness of from 300 to 400 ppm. The Schaeufele '147 patent does not teach or suggest using the composition to clean or prevent stains on a roof, stucco or outside walls caused by, for example, algae (such as Gloeocapsa magma), moss, mildew and lichen.

U.S. Pat. No. 3,934,025, issued Jan. 20, 1976 to Swered et al., discloses processes and compositions useful for inhibiting the growth of slime in water and, in particular, water used for industrial purposes. The compositions show synergistic activity against microorganisms, including bacteria, fungi, and algae, which produce slime in aqueous systems or bodies. The invention is directed specifically to use of compositions comprising a combination 1,3-dichloroacetone oxime acetate and n-alkyl dimethyl benzyl ammonium chloride.

None of the above treatments and patents, taken either singly or in combination, is seen to describe the instant invention as claimed. Thus, an exterior surface cleaner and method of use as described herein is desired.

### SUMMARY OF THE INVENTION

In a first embodiment of the invention, a method is provided for cleaning an exterior surface that is stained as a result of biological growth of an organism, such as algae, lichen, or moss, the method including the step of applying a cleaning composition having alkyl-dimethyl-benzyl-ammonium-chloride to the exterior surface. In another embodiment of the invention, a method is provided for preventing biodeterioration of an exterior surface, the method including the step of applying a cleaning composition having alkyl-dimethyl-benzyl-ammonium-chloride to the exterior surface. In yet another embodiment, an exterior surface cleaning formulation is provided that includes an effective amount of alkyl-dimethyl-benzyl-ammonium-chloride.

Accordingly, it is a principal object of the invention to provide a method for cleaning outside or exterior surfaces of buildings and other structures exposed to the elements.

It is another object of the invention to provide a method for cleaning outside or exterior surfaces stained with algae (such as Gloeocapsa magma), moss, mildew and lichen.

It is a further object of the invention to provide a method for cleaning a roof stained with Gloeocapsa magma.

Still another object of the invention is to provide a composition for cleaning outside surfaces, such as building roofs, stucco and brick walls.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1A is an environmental, perspective view of a worker applying an exterior surface cleaner according to the present invention to a building roof blighted with at least one bio-stain.

FIG. 1B is an environmental, perspective view of a treated roof that has been cleaned using a cleaning composition according to the invention.

FIG. 2A shows an outside wall that is blighted with at least one bio-stain.

FIG. 2B shows the outside wall of FIG. 2A after treatment with a cleaning composition according to the invention.

FIG. 3A shows an article of manufacture according to the invention.

FIG. 3B shows a label according to the invention.

FIG. 3C shows an alternative label according to the invention.

FIG. 3D shows a third label according to the invention.

FIG. 3E shows a fourth label according to the invention.

Similar reference characters denote corresponding features consistently throughout the attached drawings.

### DETAILED DESCRIPTION OF THE PREFERRED EMBODIMENTS

The present invention is directed to an improved method and composition for cleaning exterior surfaces. More specifically, the invention is directed to an improved method and composition for removing stains on an exterior surface, such as a roof, stucco or an outside wall caused by, for example, algae (such as Gloeocapsa magma), moss, mildew and lichen. The invention is also directed to a composition for use as a preventative agent to help prevent the development of bio-stains on an exterior surface. The terms “stain” and “bio-stain” are hereinafter regarded as equivalent terms.

In a first embodiment of the invention a method is provided for cleaning an exterior surface that is stained as a result of biological growth of an organism such as an algae, lichen, or moss. The method comprises the step of applying a cleaning composition comprising alkyl-dimethyl-benzyl-ammonium-chloride to the exterior surface.

In a second embodiment of the invention a method is provided for preventing biodeterioration of an exterior surface. The method comprises the step of applying a cleaning composition comprising alkyl-dimethyl-benzyl-ammonium-chloride to the exterior surface.

In a third embodiment of the invention, an exterior surface cleaning formulation is provided, wherein the formulation comprises an effective amount of alkyl-dimethyl-benzyl-ammonium-chloride for cleaning or preventing the formation of bio-stains on exterior surfaces.

In a fourth embodiment of the invention an article of manufacture is provided for use as a cleaning agent for application to an exterior surface that is bio-stained, or for use as a preventative agent to prevent build up of bio-stains. The article of manufacture comprises a container having a formulation therein, the formulation comprising an effective amount of alkyl-dimethyl-benzyl-ammonium-chloride, wherein the container has information printed thereon, and wherein the printed information indicates that the article of manufacture can be used for as a cleaning agent for application to an exterior surface that is bio-stained and/or can be used as a preventative agent to prevent build up of bio-stains on external surfaces, such as a modern shingle roof.

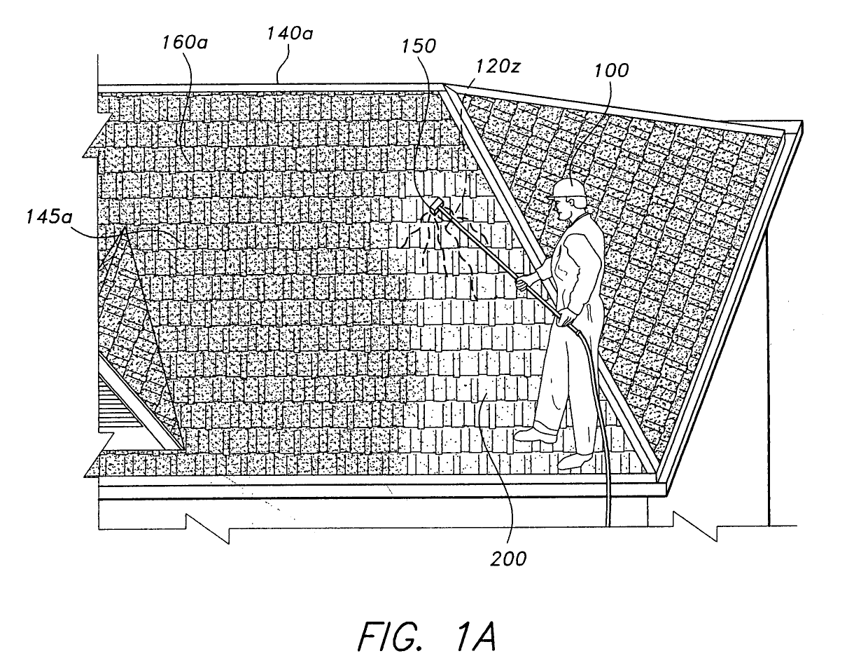

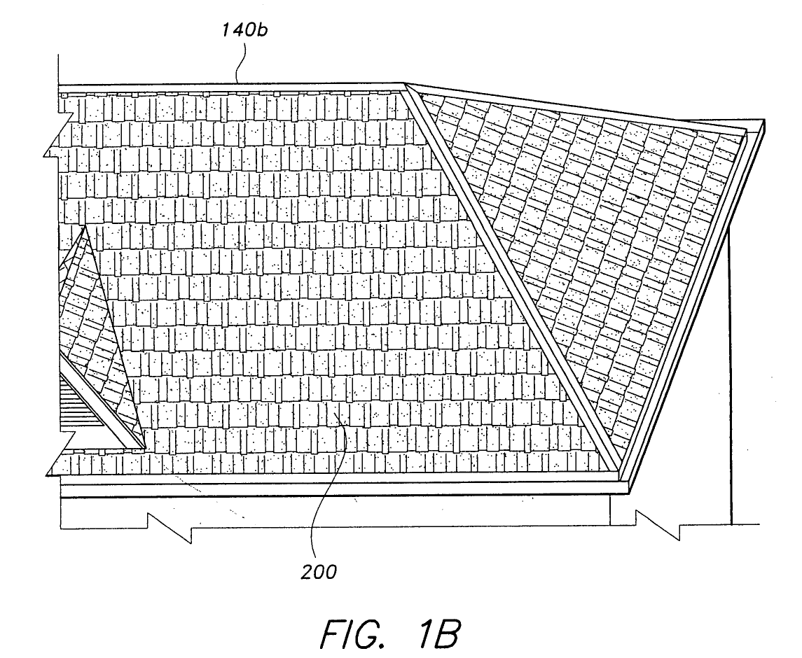

FIG. 1A shows an environmental, perspective view of a worker 100 who is shown applying a cleaning composition 120 to a building roof 140a according to the present invention. The roof 140a is blighted with at least one bio-stain 145a. The cleaning composition 120 (shown in the form of a spray 120z) is applied via a spray device 150. It should be understood that the cleaning composition 120 may be applied in a variety of ways, such as brushing or sponging onto a surface to be treated, but the preferred method of application is by spraying. The cleaning composition 120 will remove green and black bio-stains from roofs, decks, awnings, brick, and siding with or without rinsing with water. It should be understood that the term “bio-stain” refers to stains produced by organisms such as algae (e.g., Gloeocapsa magma), moss, mildew and lichen.

Still referring to FIG. 1A, the roof 140a is of the type that is vulnerable to colonization by organisms such as algae, moss, mildew, and lichen. The building roof 140a has a roof surface 160a contaminated with at least one bio-stain 145a produced by at least one organism, such as the algae Gloeocapsa magma. Thus, the cleaning composition 120 can be used to remove stains produced by more than one organism, such as stains produced by, for example, algae (such as Gloeocapsa magma), moss, mildew and lichen, alone or in combination.

The cleaning composition 120 comprises an effective amount of alkyl-dimethyl-benzyl-ammonium-chloride. Preferably, the cleaning composition 120 includes 30% by volume alkyl-dimethyl-benzyl-ammonium-chloride and 70% by volume inert ingredients, such as water and surfactants. The cleaning composition removes the bio-stain 145a to create a clean surface area 200. Treating the roof 140a with the cleaning composition 120 results in a bio-stain free roof 140b (see FIG. 1B).

The preferred form of alkyl-dimethyl-benzyl-ammonium-chloride has an alkyl chain C12-16 (i.e., CAS #: 68424-85-1).

However, the alkyl chain length might be varied, e.g., alkyl (C12-18) benzyldimethylammoniumchloride (i.e., CAS #: 68391-01-5) and alkyl (C12-14)benzyldimethylammoniumchloride (i.e., CAS #: 85409-22-9). Thus, the cleaning composition 120 may comprise of a mixture of alkyl-dimethyl-benzyl-ammonium-chloride molecules with varying alkyl chain length.

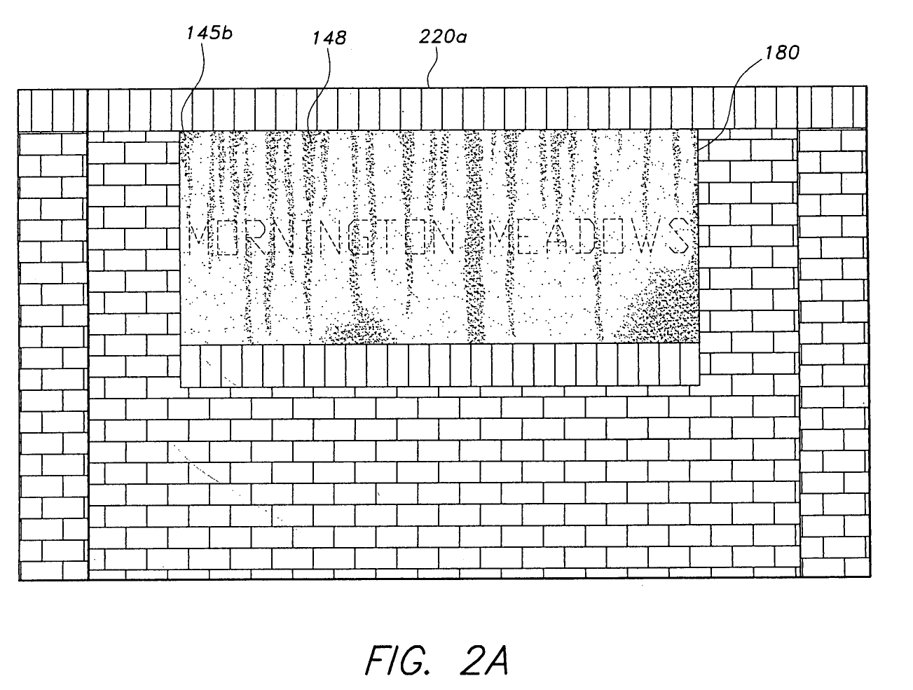

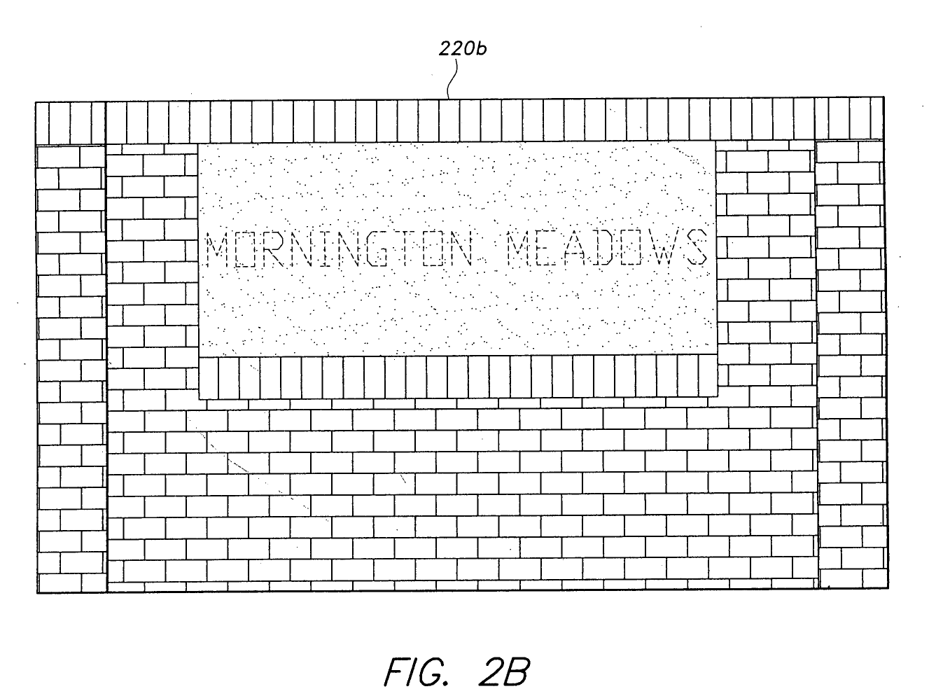

FIG. 2A shows an outside wall 220 (represented by the alpha-numeral “220a”) a that is blighted with at least one bio-stain 145b. More specifically, the wall 220a has a sign 180 disposed thereon, wherein the sign 180 is particularly blighted by the at least one bio-stain 145b, further wherein the at least one bio-stain is in the form of at least one streak 148. After treatment with the cleaning composition of the invention the wall 220 is rendered substantially bio-stain free. The substantially bio-stain free wall 220 (represented by the alpha-numeral “220b”) is shown in FIG. 2B.

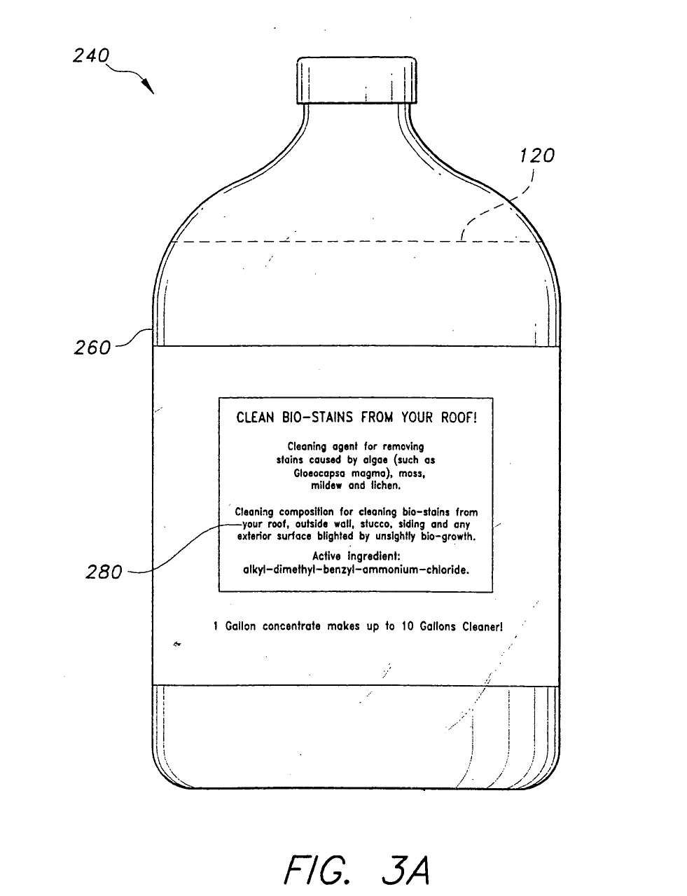

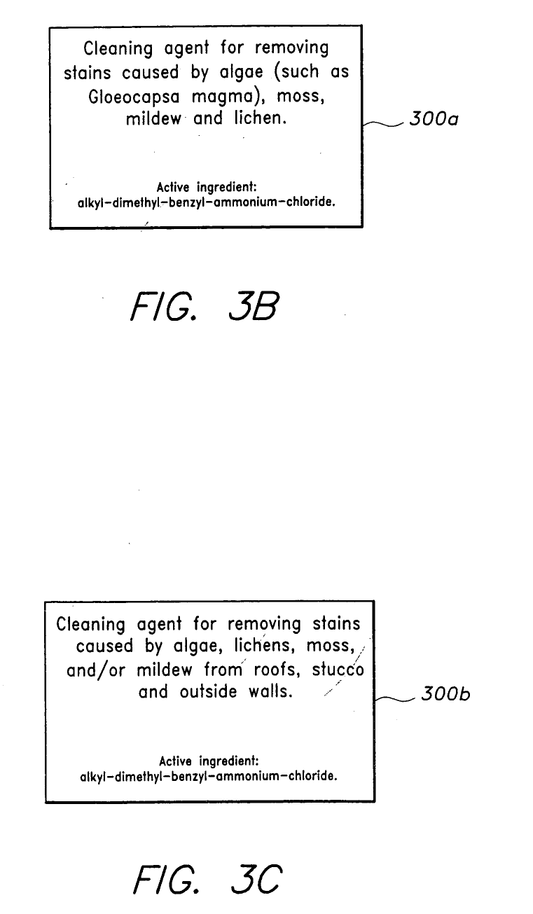

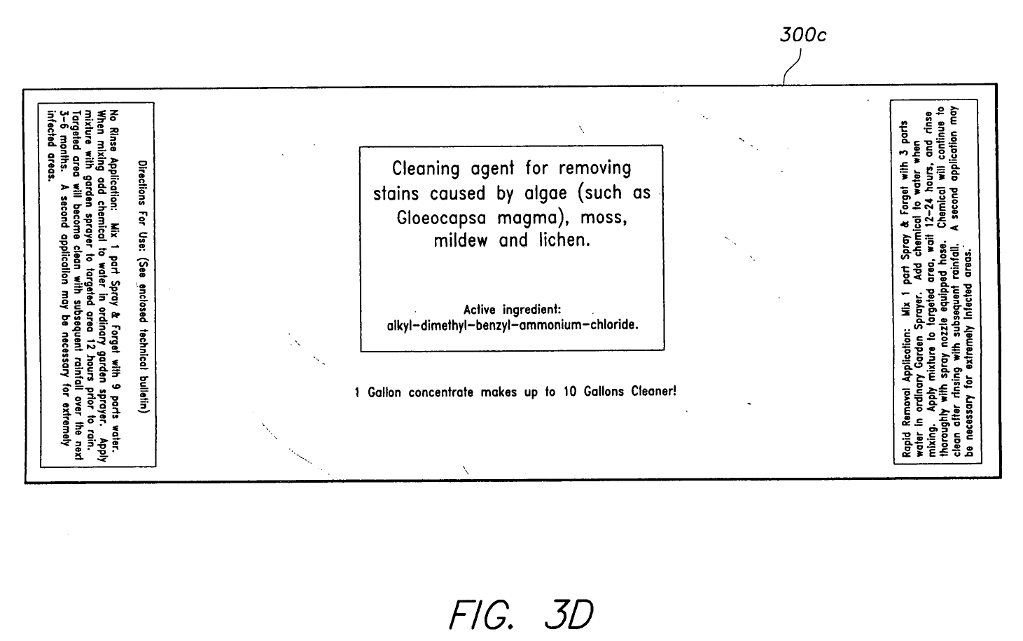

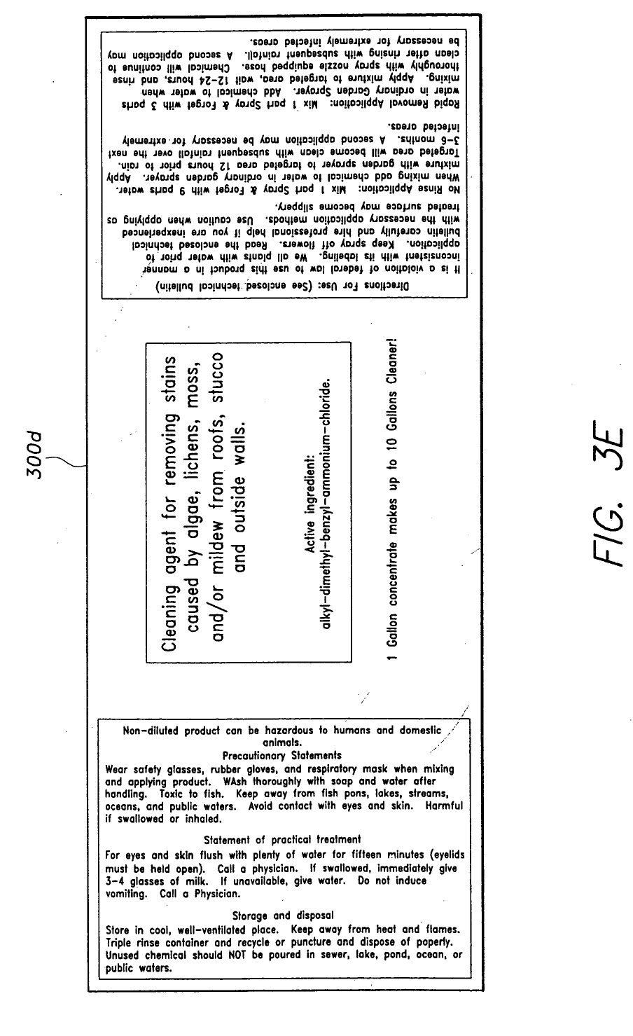

FIG. 3A shows an article of manufacture 240 comprising a container 260 with a concentrated form of the cleaning composition 120 contained therein, and words 280 printed on the container 260 or on a label (such as label 300c, see FIG. 3D) affixed to the container 260. The words 280 describe the contents of the container 260 (i.e., the cleaning composition 120 therein). Instructions for using the cleaning composition 120 can be displayed elsewhere on the container 260 or printed on paper attached to the container 260. The indicia 280 include an indication that the cleaning composition 120 contained therein is particularly useful for removing stains (i.e., bio-stains) from external surfaces, such as a roof, outside wall, stucco, and siding.

It should be understood that the exact arrangement of words 280 and/or instructions for use of the cleaning composition 120 can vary without detracting from the spirit and scope of the present invention. Additionally, the words 280 can be printed directly on the container 260 or, for example, printed on labels 300a, 300b, 300c, and 300d shown in FIGS. 3B, 3C, 3D, and 3E respectively. Likewise, it should be understood that the labels (such as labels 300c and 300d) could be attached to any type of article of manufacture 240 in the form of any suitable container 260 containing a version of the cleaning composition 120. It should be understood that the cleaning composition 120 may vary in concentration depending on the application and associated instructions instructing the intended user about mixing (i.e., diluting) the contents in the container 260.

### TREATMENT EXAMPLE 1

One gallon of the 30% by volume concentration of the cleaning composition 120 mixed with three gallons of water (i.e., a 3:1 mixture) will clean approximately 700 sq. ft. (such as 700 sq. ft. of roof 140a) using a sprayer, such as a-garden pump sprayer. One gallon of the 30% by volume concentration of the cleaning composition 120 mixed with five gallons of water (i.e., a 5:1 mixture) will clean approximately 1200 sq. ft. (such as 1200 sq. ft. of roof 140a) using a sprayer, such as a garden pump sprayer. One gallon of the 30% by volume concentration of the cleaning composition 120 mixed with nine gallons of water (i.e., a 9:1 mixture) will clean approximately 2000 sq. ft. (such as 2000 sq. ft. of roof 140a) using a sprayer, such as a garden pump sprayer.

### TREATMENT EXAMPLE 2

With respect to cleaning siding, the cleaning composition 120 is extremely effective for cleaning mildew and algae stains from siding. Prepare a treatment mixture by mixing one part 30% by volume concentration of the cleaning composition 12.0 with five parts by volume water in an ordinary garden sprayer and apply to the bio-stained effected area. Green stains will disappear in 1-3 days and black stains will disappear in 1-4 weeks. The residual effect of this treatment will keep the stains off of the treated surface for up to twelve months.

### TREATMENT EXAMPLE 3

No rinse method: with respect to roof algae/moss, the cleaning composition 120 will remove ugly black bio-stains and thick moss from shingles. Procedure: mix one part 30% by volume concentration of the cleaning composition 120 with nine parts water in an ordinary pump garden sprayer and apply to the effected area. Rinsing is generally not required since rain provides sufficient rinsing to help remove stains. Specifically, bio-stains will continue to disappear over 6-9 months with subsequent rainfall. The removal process can be expedited by using a heavier concentration (3:1 to 5:1 mix) during the application process. This will expedite the removal process to 3-6 months.

Rapid results method: rapid results can be achieved for roof algae removal by applying a 3 to 1 concentrated mix (i.e., by mixing 3 parts by volume of water mixed with 1 part by volume of the cleaning solution 120 (30% by volume concentration) , waiting twenty-four hours, and rinsing with an ordinary garden hose and spray nozzle. The person applying the mixture should be within three feet of the bio-stain when rinsing since some pressure is required. The rapid results method is dependent on water pressure that can vary from area to area. Therefore, it is preferred that a small section of the roof to be cleaned is tested using the rapid results method. If the stains are not removed then it will be necessary to use the no rinse application method as described above. The rapid results method will not work for roof moss (thick moss growth) applications and it will be necessary to use the no rinse method.

### TREATMENT EXAMPLE 4

Preventive Maintenance Method: it is much easier to keep roof algae and moss off of a roof then it is to remove it once it is on your roof. Apply, to a roof, a mix of nine parts water to one part 30% by volume concentration of the cleaning composition 120 every 18-24 months to act as a preventative to prevent the reappearance of roof bio-stains and/or moss. It should be understood that the preventative maintenance method could be applied to other types of outdoor surfaces such as brick walls, stucco, siding, and stone, alone or in combination.

### TREATMENT EXAMPLE 5

30% by volume

Brick/Stucco/Stone, the cleaning composition 120 is extremely effective for cleaning mildew and algae bio-stains from brick, stucco and stone surfaces. Mix one part by volume of 30% by volume concentration of the cleaning composition 120 with five parts by volume water in an ordinary garden sprayer and apply to the effected area. No rinsing is required. Green stains will disappear in 1-3 days and black stains will disappear in 1-4 weeks. A second application may be required for extreme concentrations of black mildew/mold. The residual effect of this application will act as a preventative by keeping the stains off of the treated surface for up to 12 months.

It is to be understood that the present invention is not limited to the embodiments described above, but encompasses any and all embodiments within the scope of the following claims.

1. A method for cleaning an exterior surface, comprising the step of applying a cleaning composition comprising alkyl-dimethyl-benzyl-ammonium-chloride to the exterior surface.

2. The method according to claim 1, wherein the cleaning composition includes 30% by volume alkyl-dimethyl-benzyl-ammonium-chloride.

3. The method according to claim 2, further comprising the step of mixing one part of the cleaning composition with three parts water prior to applying the composition to the exterior surface.

4. The method according to claim 2, further comprising the step of mixing one part of the cleaning composition with five parts water prior to applying the composition to the exterior surface.

5. The method according to claim 2, further comprising the step of mixing one part of the cleaning composition with nine parts water prior to applying the composition to the exterior surface.

6. The method according to claim 1, further comprising the steps of:
mixing one part by volume of the cleaning composition with three parts by volume water prior to applying the cleaning composition to the exterior surface; and
rinsing the exterior surface with water twenty-four hours after applying the composition to the exterior surface.

7. The method according to claim 1, wherein the alkyl-dimethyl-benzyl-ammonium-chloride has a hydrocarbon chain with 12-16 carbon atoms.

8. The method according to claim 1, wherein the alkyl-dimethyl-benzyl-ammonium-chloride has a hydrocarbon chain with 12-14 carbon atoms.

9. The method according to claim 1, wherein the alkyl-dimethyl-benzyl-ammonium chloride has a hydrocarbon chain with 12-18 carbon atoms.

10. A method for preventing biodeterioration of an exterior surface, comprising the step of applying a cleaning composition including alkyl-dimethyl-benzyl-ammonium-chloride to the exterior surface.

11. The method according to claim 10, further comprising the steps of:
mixing one part by volume of the cleaning composition with nine parts by volume water prior to applying the cleaning composition to the exterior surface;
reapplying the cleaning composition to the exterior surface every 18-24 months.

12. The method according to claim 10, wherein the cleaning composition includes 30% by volume alkyl-dimethyl-benzyl-ammonium-chloride.

13. The method according to claim 10, wherein the alkyl-dimethyl-benzyl-ammonium-chloride has a hydrocarbon chain with 12-16 carbon atoms.

14. The method according to claim 10, wherein the alkyl-dimethyl-benzyl-ammonium-chloride has a hydrocarbon chain with 12-14 carbon atoms.

15. The method according to claim 10, wherein the alkyl-dimethyl-benzyl-ammonium-chloride has a hydrocarbon chain with 12-18 carbon atoms.

16. An exterior surface cleaning formulation, comprising an effective amount of alkyl-dimethyl-benzyl-ammonium-chloride.

17. The exterior surface cleaning formulation of claim 16, wherein the. formulation is disposed within a container, said container having information printed thereon, the printed information indicating that the article of manufacture can be used as a cleaning agent for application to an exterior surface that is bio-stained and as a preventative agent to prevent build-up of bio-stains on external surfaces, such as a modern shingle roof.
